(19) United States
(12) Patent Application Publication
(10) Pub. No.: US 2023/0003452 A1
(43) Pub. Date: Jan. 5, 2023

(54) Device for melting, use and method

(71) Applicants: Franco PROCACCIANTE, Freigericht (DE); Fikret HILALOGLU, Karlstein (DE)

(72) Inventors: Franco PROCACCIANTE, Freigericht (DE); Fikret HILALOGLU, Karlstein (DE)

(21) Appl. No.: 17/781,193

(22) PCT Filed: Jul. 9, 2021
(86) PCT No.: PCT/DE2021/000117

§ 371 Date: May 31, 2022

(30) Foreign Application Priority Data
Nov. 10, 2020 (DE) 10 2020 006 897.9
Apr. 14, 2021 (DE) 10 2021 001 936.9

(51) Int. Cl. F27B 14/04; F27D 3/14; F27D 3/15

(52) U.S. Cl. CPC F27B 14/04; F27D 3/14; F27D 3/1545

(57) ABSTRACT

A device for melting a metal-containing mixture includes a vacuum melting furnace, in particular with a plasma jet melting means. A metal-containing mixture, in particular catalysts from motor vehicles, is to be fed into a graphite pool through a feed line. A first lateral discharge opening can be inserted into the graphite pool for discharging metal melt, and a second lateral discharge opening, specifically a siphon discharge opening, is provided for molten slags. The discharge openings are to be inserted through a wall of the graphite pool by a piercing lance. The lateral siphon discharge opening comprises an attached siphon with an integrated slag brick. An adaptively designed metal cover plate close to the outlet opening is inserted, in particular a copper cover plate, which is prepared in such a way that it is designed to be replaceable even when the vacuum melting furnace is running.

### TECHNICAL FIELD

The disclosure relates to a device for melting a metal-containing mixture, in particular a precious metal-containing melting material and to a method for operating a device for melting a metal-containing mixture.

### BACKGROUND

It is well-known that metal melting furnaces, which are operated at high temperatures with mixtures of materials, have to be regularly shut down at great expense with regard to the maintenance of wear-prone components and have downtimes of several days.

### SUMMARY

It is an object of the present disclosure to provide a melting device that enables simple and safe maintenance.

The object is achieved by a device for melting a metal-containing mixture, in particular a precious metal-containing melting material. The device comprises a vacuum melting furnace, in particular with a plasma jet melting means. A heated melting material, comprising the metal-containing mixture, is to be held in a graphite pool. The metal-containing mixture, in particular of a precious metal-containing melting material, in particular catalysts from internal combustion engine motor vehicles, is to be fed into the graphite pool through a feed line. A first lateral discharge opening can be inserted into the graphite pool for discharging metal melt, in particular precious metal melt. A second lateral discharge opening, specifically a siphon discharge opening, is provided for molten slags. The discharge openings are to be inserted through a wall of the graphite pool by a piercing lance. The lateral siphon discharge opening comprises an attached siphon with an integrated slag brick. An adaptively designed metal cover plate close to the outlet opening is inserted, in particular a copper cover plate, which is prepared in such a way that it is designed to be replaceable even when the vacuum melting furnace is operating.

The device allows a vacuum melting furnace to be reliably maintained. Maintenance is carried out quickly and on a timely basis before an undesirably large quantity of valuable metals, in particular precious metals, escape from an excessively large slag outlet opening. The removal of the metal cover plate close to the outlet opening, in particular a copper cover plate, is possible by replacement means, even with the vacuum furnace intact, without having to disassemble the furnace. Furthermore, the invention avoids excessive wear of a slag brick arranged in the siphon or enables the sufficient cooling of the slag brick. Instead of a complete replacement of the vacuum furnace, which can take approximately 2 weeks, maintenance can now be completed within a few hours.

It is advantageous if the metal cover plate close to the outlet opening, in particular a copper cover plate, is designed to be replaceable in a removal direction.

It is advantageous if side walls are provided in the siphon in the region of the metal cover plate, and detachable retainers are provided in the metal cover plate, in particular a copper cover plate, in particular with corresponding recesses in the metal cover plate, in particular a copper cover plate.

It is advantageous if side retainers are provided on the side walls and the removable metal cover plate is removably adapted to the side retainers.

It is advantageous if adapted stepped bevels are provided in the side retainers and corresponding bevels are provided on short sides of the metal cover plate.

It is advantageous if fasteners are provided for retaining on side retainers, in particular at least two and/or three fasteners in each case.

It is advantageous if the adaptively designed removable copper cover plate has a predetermined height of at least approximately the size of a siphon discharge opening to be pierced with the piercing lance, in particular approximately twice to approximately three times the size.

It is advantageous if a replacement sensor system is provided, which emits a replacement signal from a predetermined opening size in the removable metal cover plate, in particular a copper cover plate.

The object is also achieved by a use of a removable metal cover plate, in particular a copper cover plate, in a siphon at a vacuum melting furnace for separating a slag fraction from the heated melt material melted in a graphite pool of the vacuum melting furnace, wherein a removal can be undertaken in a removal direction within the siphon, in particular in a device as disclosed herein.

The object is also achieved by a method for operating a device for melting a metal-containing mixture, in particular a precious metal-containing melting material, comprising a vacuum melting furnace, in particular with a plasma jet melting means, wherein heated melting material, comprising the metal-containing mixture, is held in a graphite pool, wherein metal-containing mixture, in particular a precious metal-containing melting material, in particular catalysts from internal combustion engine motor vehicles, is fed into the graphite pool through a feed line, wherein a first lateral discharge opening can be inserted into the graphite pool for discharging metal melt, in particular precious metal melt, and a second lateral discharge opening, specifically a siphon discharge opening, is provided for molten slags, wherein the discharge opening is inserted through a wall of the graphite pool by a piercing lance, wherein the lateral siphon discharge opening comprises an attached siphon with an integrated slag brick, wherein an adaptively designed metal cover plate close to the outlet opening is inserted, in particular a copper cover plate, which is prepared in such a way that it is replaced even when the vacuum melting furnace is operating.

Further features and advantages of the invention are apparent from the claims and the following description, in which exemplary embodiments of the subject matter of the invention are explained in more detail in conjunction with the drawings.

### BRIEF DESCRIPTION OF THE DRAWINGS

FIG. 1 is a sectional view of a device for melting a metal-containing mixture.

FIG. 2 is a detailed view of a device for melting a metal-containing mixture.

FIG. 3 is a detailed view of a device for melting a metal-containing mixture.

FIG. 4 is a detailed view of a device for melting a metal-containing mixture.

FIG. 5 is a detailed view of a device for melting a metal-containing mixture.

### DETAILED DESCRIPTION

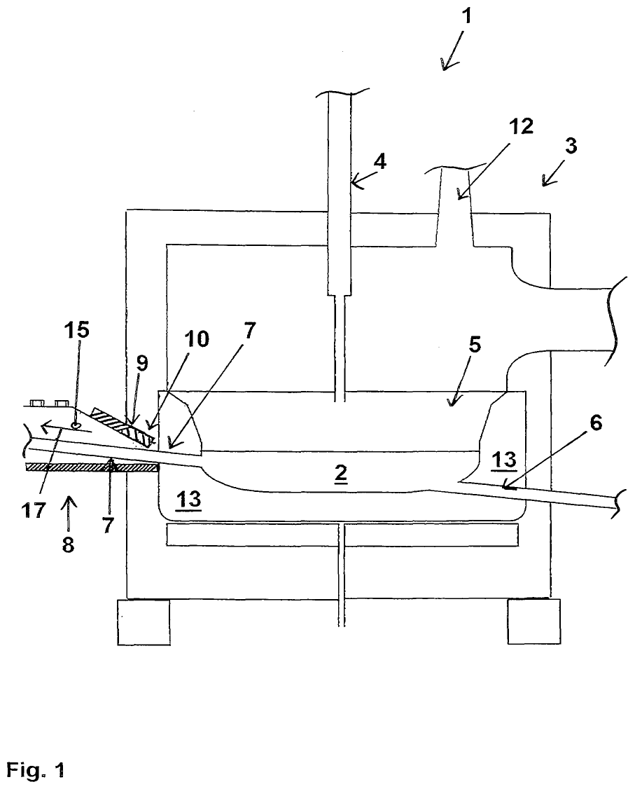

FIG. 1 shows a schematic device 1 for melting a metal-containing mixture, in particular a precious metal-containing melting material 2, comprising a vacuum melting furnace 3, in particular with a plasma jet melting means 4, wherein heated melting material 2, comprising the metal-containing mixture, is to be held in a graphite pool 5, wherein metal-containing mixture, in particular of a precious metal-containing melting material 2, in particular catalysts from internal combustion engine motor vehicles, is to be fed into the graphite pool 5 through a feed line 12, wherein a first lateral discharge opening 6 can be inserted into the graphite pool 5 for discharging metal melt, in particular precious metal melt, and a second lateral discharge opening 7, specifically a siphon discharge opening 8, is provided for molten slag, wherein the discharge openings 6, 7 are to be inserted through a wall 13 of the graphite pool 5 by a piercing lance, wherein the lateral siphon discharge opening 8 has an attached siphon 14 with an integrated slag brick 15, wherein an adaptively designed metal cover plate 9 close to the outlet opening is inserted, in particular a copper cover plate 10, which is prepared in such a way that it is designed to be replaceable even when the vacuum melting furnace 3 is running, wherein the metal cover plate 9 close to the outlet opening, in particular a copper cover plate 10, is designed to be replaceable in a removal direction 17.

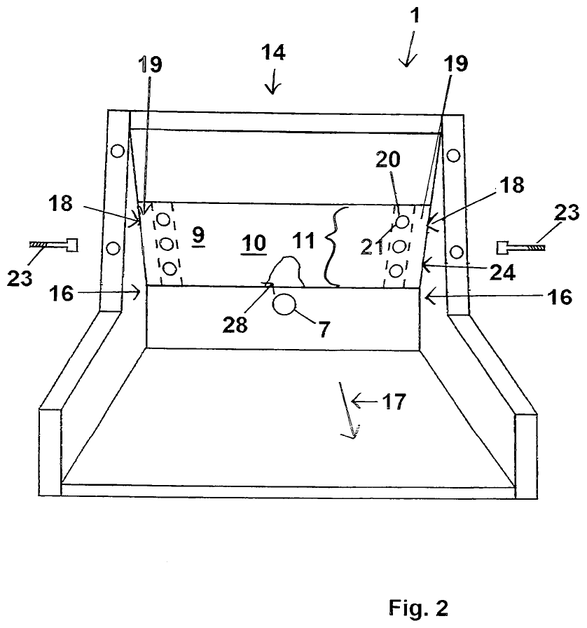

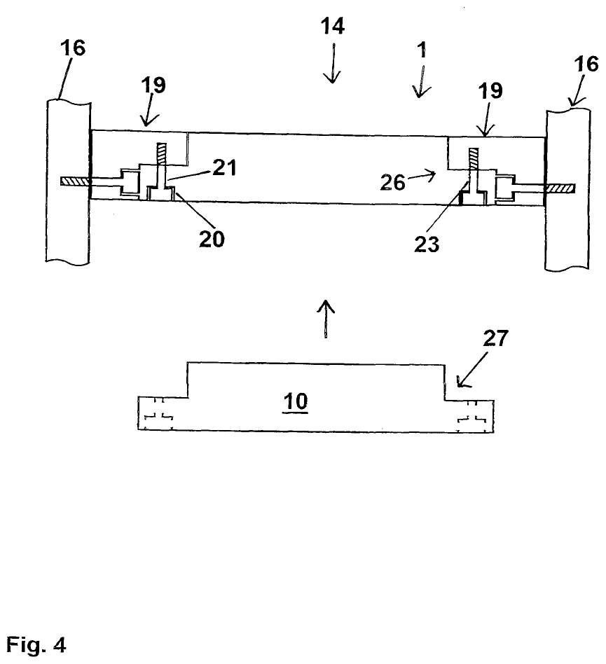

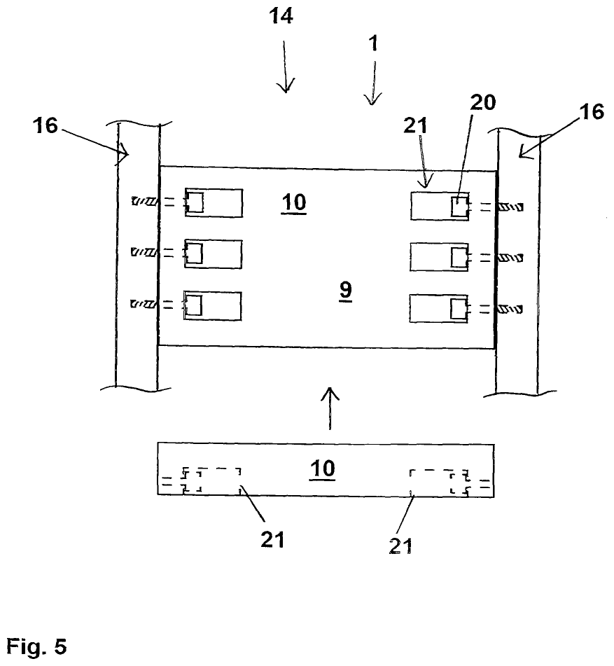

FIG. 2 shows a device 1, wherein the siphon 14 has side walls 16 in the region 18 of the metal cover plate 9, and detachable retainers 20 are provided in the metal cover plate 9, in particular a copper cover plate 10, with an exemplary damage opening 28 by application of a piercing lance (not shown) during the operation of the vacuum furnace, in particular with corresponding recesses 21, by way of example also shown in FIGS. 4, 5, in the metal cover plate 9, in particular a copper cover plate 10, wherein side retainers 19 are provided on the side walls 16 and the removable metal cover plate 9 is removably adapted to the side retainers 19, in particular removable in a removal direction 17.

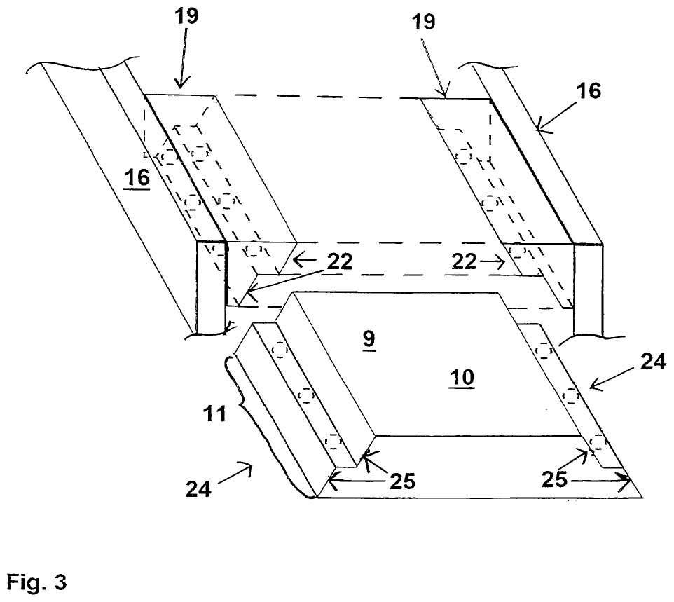

FIG. 3 shows a device 1 in detail, wherein adapted stepped bevels 22 are provided in the side retainers 19 and corresponding bevels 25 are provided on short sides 24 of the metal cover plate 9.

FIG. 4 shows a detailed view of a device with retaining steps 26 in side retainers 19 along with adapted retaining steps 27 in the metal cover plate 9.

FIG. 5 shows a detailed view of a device 1 with retainers 20 and recesses 21 for the advantageous replacement of the metal cover plate 9.

### LIST OF REFERENCE SIGNS

1 Device for melting

2 Melting material

3 Vacuum melting furnace

4 Plasma jet melting means

5 Graphite pool

6 First lateral discharge opening

7 Second lateral discharge opening

8 Siphon discharge opening

9 Metal cover plate

10 Copper cover plate

11 Height

12 Feed line

13 Wall

14 Siphon

15 Slag brick

16 Side wall

17 Removal direction

18 Region

19 Side retainers

20 Retainers

21 Recess

22 Bevel

23 Fasteners

24 Short side

25 Bevel

26 Retaining step

27 Retaining step

28 Damage opening

1-10. (canceled)

11. A device (1) for melting a metal-containing melting material (2), comprising:
a vacuum melting furnace (3);
a graphite pool (5) which holds the heated melting material (2);
a feed line (12) through which the melting material (2) is fed into the graphite pool (5);
a first lateral discharge opening (6) which can be inserted into the graphite pool (5) for discharging the molten melting material; and
a lateral siphon discharge opening (7,8) which is provided for molten slag,
wherein the first lateral discharge opening (6) and the lateral siphon discharge opening (7) are inserted through a wall (13) of the graphite pool (5) by a piercing lance,
wherein the lateral siphon discharge opening (8) has an attached siphon (14) with an integrated slag brick (15),
wherein an adaptively designed metal cover plate (9) is arranged proximal to the lateral siphon discharge opening (7,8), which is designed to be replaceable even while the vacuum melting furnace (3) is operating.

12. The device according to claim 11,
wherein the metal cover plate (9) is a copper cover plate (10) and designed to be replaceable in a removal direction (17).

13. The device according to claim 11,
wherein side walls (16) are provided in the siphon (14) in a region (18) of the metal cover plate (9), and
detachable retainers (20) are provided in the metal cover plate (9) with corresponding recesses (21) in the metal cover plate (9).

14. The device according to claim 13,
wherein side retainers (19) are provided on the side walls (16) and
wherein the removable metal cover plate (9) is removably adapted to the side retainers (19),

15. The device according to claim 14,
wherein adapted stepped bevels (22) are provided in the side retainers (19) and
wherein corresponding bevels (25) are provided on short sides (24) of the metal cover plate (9).

16. The device according to claim 14,
wherein at least two fasteners (23) are provided for retaining on side retainers (19).

17. The device according to claim 12,
wherein the adaptively designed removable copper cover plate (10) has a predetermined height (11) of at least twice the size of the siphon discharge opening (8) to be pierced with the piercing lance.

18. The device according to claim 11, further comprising
a replacement sensor system which emits a replacement signal from a predetermined opening size (26) in the removable metal cover plate (9).

19. A method, comprising:
providing the device according to claim 1;
using the removable metal cover plate (9) in the siphon (14) at the vacuum melting furnace (3) for separating the slag from the heated melting material (2) melted in the graphite pool (5),
wherein a removal can be undertaken in a removal direction (17) within the siphon (14).

20. A method, comprising:
providing the device according to claim 12;
feeding catalysts from internal combustion engine motor vehicles as the metal-containing melting material (2) into the graphite pool (5); and
replacing the copper cover plate (10) while the vacuum melting furnace (3) is operating.
